(19) United States
(12) Patent Application Publication
(10) Pub. No.: US 2012/0000343 A1
(43) Pub. Date: Jan. 5, 2012

(54) NESTED DRUM SET

(75) Inventor: Ami Rothenberg, Athens (GR)

(73) Assignee: AMI DRUMS LTD, London (GB)

(21) Appl. No.: 13/254,450

(22) PCT Filed: Mar. 4, 2010
(86) PCT No.: PCT/IL2010/000180

§ 371 Date: Sep. 1, 2011

(30) Foreign Application Priority Data
Mar. 5, 2009 (US) 61157563

(51) Int. Cl. G10D 13/02

(52) U.S. Cl. 84/421

(57) ABSTRACT

The invention provides nesting drum set designs suitable for packaging drums having standard height (depth) and standard drum head and fastening frames sizes in a self-contained fashion, wherein some of the drums have drum head diameter differences of circa 2″ one from the other, thereby providing a compact and relatively lightweight packed drum set that can be comfortably transported or stored while occupying substantially small storage/luggage space.

### FIELD OF THE INVENTION

The present invention relates generally to a new type of musical drum set. More particularly, the present invention relates to a new type of musical drum set particularly useful for storage and transport purposes.

### BACKGROUND OF THE INVENTION

A musical drum set typically consists of a bass drum, a snare drum, and one or more tom toms. Musical drums in standard drum sets typically have even diameters measured in inches, ranging from 6″ to 26″, standard diameters being 8″, 10″, 12″, 14″, 16″, 18″, 20″, 22″, and 24″. Some drum sets contain 13″ and/or 15″ diameter drums. Drum head manufacturers make drum heads specifically to fit the standard diameters.

Transportation or storage of such standard drum sets typically involves packaging each drum in a special bag or case designed to accommodate it and carrying/storing each bag/case. This packaging approach requires significant luggage/storage space and also involves much labor in packaging, carrying and arranging the packaged drum set, and also in unpacking it and assembly of the drum set for playing it.

In the past there have been attempts to make drum sets in which the drums fit into one another for storage and transport. In some of these attempts some of the drums were opened by opening the drum shell or removing the drum head with a quick release mechanism in order to allow smaller drums to be packed inside them. Typically, the smallest drum did not open as there was no need to place another drum inside it. This type of drum set is sometimes referred to as a nesting drum set.

The problem with these nesting drum sets is that fitting one drum inside another requires a difference in diameter of at least ˜3″. This 3″ gap is needed because of the combined diameter of the drum shell and the size of the lugs and hardware mounted on each drum shell (e.g., drum suspension mount). This makes it impossible to make a nesting drum set containing the standard tom-tom drums having circa 2″ diameter differences, and accordingly nesting drum sets heretofore were designed with drums having diameters differences of more than 2″, at least circa 3″. For example, drums of sizes 10″, 13″, 16″, 22″ have been made to form a nesting kit.

In another attempt, described in U.S. Pat. No. 6,211,448, the content of which is incorporated herein by reference, the packaging of a small drum set is accomplished by means of a two part 14″ to 20″ bass drum designed to be opened and to have an appropriate depth for accommodating two tom-tom drums and a snare drum one on top of the other inside it. While this solution partially solves the packaging problem of small drum sets (one bass drum with three small drums inside it), it requires using a bass drum which is relatively deep and with a relatively small diameter, which can affect the systems weight and sound. Because of its uncommon size, the bass drum, which can be for example 16″(diameter)×20″(depth) does not sound like a full sized bass drum. This design also requires the aforementioned tom toms to be uncommonly shallow in depth, which also affects their sound. For example a set with 12×6.5″ and 14×8.5″ tom toms, or even a set with 10×6″ and 13×7″ tom toms. Needless to say, the tom toms of these sizes do not sound like regular size tom toms. (An non limiting example of regular size tom toms could be 10″×8″, 12″×9″, 14×14″).

The methods described above have not yet provided satisfactory nesting drum sets solutions. There is therefore a need for improved nesting drum set designs that overcome the above mentioned problems.

It is therefore an object of the present invention to provide nesting drum set designs suitable for packaging three or more drums.

It is another object of the present invention to provide nesting drum set designs suitable for packaging drum sets in which some of the drums have a standard circa 2″ difference in diameter from other drums in the set.

It is a further object of the present invention to provide nesting drum set designs which are relatively lightweight and can be rapidly unpacked and assembled for playing.

It is a further object of the present invention to provide nesting drum set designs which are relatively compact and space saving when packed up, yet contain full size tom toms and bass drums and when assembled and played, look and sound like a normal size drum set.

Other objects and advantages of the invention will become apparent as the description proceeds.

### SUMMARY OF THE INVENTION

The present invention provides nesting drum set designs suitable for conveniently packaging drums having standard height (depth) and standard drum head and fastening frames (also known as “drum hoops” or “drum rims”) sizes in a self-contained fashion (i.e., one inside the other), wherein some of the drums have drum head diameter differences of circa 2″ one from the other, thereby providing a compact and relatively lightweight packed drum set that can be comfortably transported or stored while occupying substantially small storage/luggage space. Advantageously, the nesting drum set designs of the present invention do not require adjustments in the height (depth) of the drums, and they are preferably constructed employing standard drum heads and standard size fastening frames.

The term nesting drum set used herein refers to a drum set comprised of drums which are of different sizes and configured to be packed one inside the other such that each one of the drums, excluding the drum of greatest size, is packed inside another drum bigger than it in size in said set of drums, such that all of the drums are eventually packed in the drum having the greatest size. The term “circa” used herein with reference to diameters of drum elements means that the diameter of the drum element referred to is approximately, or about, the indicated value, as commonly used in the musical drum industry.

As is well known in the art the diameters of the shells and fastening frames of drums having different head diameters are also different. The difference in diameters of the drum heads of some of the drums in the nesting drum set of the invention is as little as circa 2″. For example, a drum having a drum head the diameter of which is greater than the diameter of a drum head of another drum by circa 2″, will also have a drum shell and fastening frame the diameters of which are greater by about 2″. It is also noted that the 2″ diameter difference, or circa 2″ difference, refers to the difference between standard drum heads, drum hoops, and drum shells, that are commonly known as 6″, 8″, 10″, 12″, 14″, 16″, 18″, 20″, 22″, 24″, elements, even though their diameters are sometimes circa (about) the exact indicated inch values (not precisely).

The inventor of the present invention found out that it is possible to construct nesting drum sets having drums with head diameter differences of as little as circa 2″ by designing the drums to be mounted in removable mounting hardware, such that no mounting hardware is permanently attached to them, and by using a new lug design that reduces the lug's thickness in order that the lugs do not protrude beyond the perimeter of the fastening frames of the drums. It was also found that the internal volume of the drums of the invention may be further adjusted for accommodating thereinside a drum having a smaller size (e.g., placing a 14″ drum inside a 16″ drum) by constructing the shell of the drums from materials (e.g., metals, multilayered structures comprised of plastic and metallic layers) permitting substantial reduction of the wall thickness of the shell of the drums, and/or by increasing the diameter of the drum shell while ensuring it still fits with the standard size drum head (i.e., reduction in the distance between the drum shell and the side of the drum head which touches the drum shell from the outside, without increasing the thickness of the drum shell).

Accordingly, in one aspect, the present invention is directed to a musical drum comprising a drum shell, one or two drum heads, one or two fastening frames, lugs bolts and nuts, for fastening said one or two drum heads to said drum shell by means of said one or two fastening frames, said musical drum is configured to be mounted in a removable suspension mount such that no mounting hardware is permanently attached to it, wherein said lugs are configured such that they do not protrude beyond the perimeter of said fastening frame, thereby allowing the packaging of said drum inside another drum the head size of which is greater by as little as circa 2″ and the shell of which is capable of being opened and accessed (i.e., for placing the drum in its internal space).

The drum shell may be comprised of two shell portions configured to be reversibly fastened to each other by fastening means, thereby allowing convenient access to the interior space of the musical drum and allowing placing thereinside a similar musical drum the drum head of which is smaller in diameter than the diameter of said musical drum by as little as circa 2″. The attachment surface of the shell portions may optionally include a circumferential seal made from a soft and/or flexible material, such as, but not limited to, rubber or a type of silicone.

According to another aspect the present invention is directed to a nesting drum set which is comprised of drums that are of different sizes, each comprising a drum shell, one or two drum heads, one or two fastening frames, and lugs, bolts and nuts, for fastening said drum heads to said drum shell. Said drums are configured to be mounted in a removable suspension mount such that no mounting hardware is permanently attached to them, wherein the lugs of said drums are configured such that they do not protrude beyond the perimeter of said fastening frame, and wherein the drum shells of each of said drums, excluding the smallest drum, are comprised of two shell portions reversibly attached to each other by fastening means.

Advantageously, in preferred embodiments of the invention the diameter of the drum shell may be increased (e.g., by about 0.5 mm to 2.5 mm) relative to the diameter of a standard drum shell used with the same drum head, while ensuring it still fits with the drum head, thereby reducing the distance between the drum shell and the drum head and increasing the drum shell's internal volume without increasing the wall thickness of the drum shell. Additionally or alternatively, in preferred embodiments of the invention the wall thickness of the drum shell is made relatively thin (e.g., about 1 mm to 4 mm) thereby increasing its internal diameter and providing more space inside the drum without affecting the outer diameter of the drum shell. Optionally, the drum shell is made from a multilayered material comprising at least three layers, said layers may advantageously include Aluminum layers and plastic layers (e.g., polyethylene), and the thickness of said multilayered material is preferably about 1 mm to 4 mm.

In preferred embodiments of the invention the nuts are implemented by a type of cylindrical nut having an elongated and narrow profile. Advantageously, the cylindrical nut comprises a bore passing in perpendicular relative to the elongated axis of the cylindrical nut about the middle of its length; said bore has screw threads suitable for mating with the screw threads of the bolts. Additionally or alternatively, the lugs are comprised of a base portion adapted to be attached to the drum shell and a pair of arms projecting from said base portion in a radial direction relative to the drum shell, said arms are substantially parallel and each extends from the bottom side of said lugs to their upper side, thereby forming a vertical gap allowing passage of the bolts therethrough. Advantageously, the bottom sides of the arms of the lugs may comprise oval dents adapted to receive the cylindrical nuts.

In preferred embodiments of the invention the portions of the drum shell may be fastened to each other by external or internal fastening means. For example, draw latch units, sash locks, link locks, or similar locking means may be attached on the external surface of the drum shells for securing the drum shell portions of each drum to one another. In one specific preferred embodiment of the invention the drum shell portions of the drums are fastened to each other by means of internal fastening means attached on the internal surface of the drums shell portions. For example, the internal fastening means may be comprised of a pair of latch units each comprising a base section adapted to be attached to the internal surface of a shell portion, and an “L”-shaped latching section extending from said base section and configured to be engaged in the “L”-shaped latching section of the other latch unit, so that the “L”-shaped latching sections of the pair of latch units are configured to be engaged one in the other. Preferably, the base sections of the latch units further comprise magnet members attached to them for applying attraction forces between said latch units.

Advantageously, at least some of the bolts have an increased length (e.g., about 55 mm to 85 mm) for allowing them to be mounted in a detachable suspension mount. For example, the increased length bolts protruding beneath the lugs may be received in suspension ears provided in the detachable suspension mount.

According to yet another aspect the present invention is directed to a method for manufacturing a nesting drum set comprised of drums which are of different sizes, the method comprising:
providing suitable drum heads and fastening frames for said drums, and bolts, nuts and lugs, said nuts and lugs are configured to not protrude beyond the perimeter of the fastening frame when engaged in said bolts;
constructing a shell for each of said drums, wherein the shell of the smallest drum is made in a form of a standard drum shell, and the shells of all other drums are constructed to comprise two shell portions configured to be attached to each other by means of internal or external fastening mechanisms;
attaching said lugs over the external surfaces of the drum shells and attaching said fastening means over respective internal or external surface locations of the drum shells comprising two shell portions;
attaching a circumferential seal over the attachment surface of the shell portions; and
attaching said drum heads by means of said fastening frames, bolts, lugs and nuts.

### BRIEF DESCRIPTION OF THE DRAWINGS

The present invention is illustrated by way of example in the accompanying drawings, in which similar references consistently indicate similar elements and in which:

FIGS. 1A to 10 schematically illustrate one preferred embodiment of the nesting drum set of the invention, wherein FIG. 1A shows an exploded view of the drums as they are being packaged, FIG. 1B shows the different drums in an opened state, and FIG. 1C provides a closer view of a lug design used in preferred embodiments of the invention;

FIGS. 2A and 2B schematically illustrate a drum according to one preferred embodiment of the invention, designed to accommodated a smaller drum thereinside, and closed by means of an external locking mechanism, wherein FIG. 2A shows the drum in a closed state and FIG. 2B provides a closer view of the drum in an opened state;

FIGS. 3A and 3B schematically illustrate a drum according to another preferred embodiment of the invention designed to be closed by means of an internal closing mechanism, wherein FIG. 3A shows the drum in an opened state and FIG. 3B shows a closer view of the drum and its locking mechanism;

FIGS. 4A to 4C show various views of the internal locking mechanism according to a preferred embodiment of the invention, wherein FIG. 4A shows a perspective front view of the locking mechanism in an unlocked state, FIG. 4B shows a perspective front view of the locking mechanism in a locked state, and FIG. 4C shows a perspective rear view of the locking mechanism in a locked state;

FIGS. 5A to 5C show images of an exemplary nesting drum set, wherein FIG. 5A shows the nesting drum set in an opened state wherein the top and bottom parts of the drums are placed one inside the other in a nested fashion (excluding the smallest drum, t10, which is constructed in one piece, placed in a nested fashion whole inside the larger nested drums, in the top half of picture), FIG. 5B shows an image of the nesting drum set in a packaged state, and FIG. 5C shows the nesting drum set in an unpacked state wherein the drums are piled one on top of the other;

FIGS. 6A and 6B show images of an internal locking mechanism used in the drum set shown in FIGS. 5A to 5C, wherein FIG. 6A shows a locking member without a securing magnet and FIG. 6B shows a locking member having a securing magnet; and

FIGS. 7A and 7B show images of a removable suspension mount as used in a preferred embodiment of the invention, wherein FIG. 7A shows the suspension mount before placing the drum in it and FIG. 7B shows the suspension mount with a drum placed in it.

It is noted that the embodiments exemplified in the Figs. are not intended to be in scale and are in diagram form to facilitate ease of understanding and description.

### DETAILED DESCRIPTION OF PREFERRED EMBODIMENTS

The present invention provides nesting drum set designs suitable for conveniently packaging standard size drum sets containing some drums having circa 2″ drum head diameter differences from one another, in a self-contained fashion, and providing a compact and relatively lightweight packed drum set that can be comfortably transported or stored while occupying substantially small storage/luggage space.

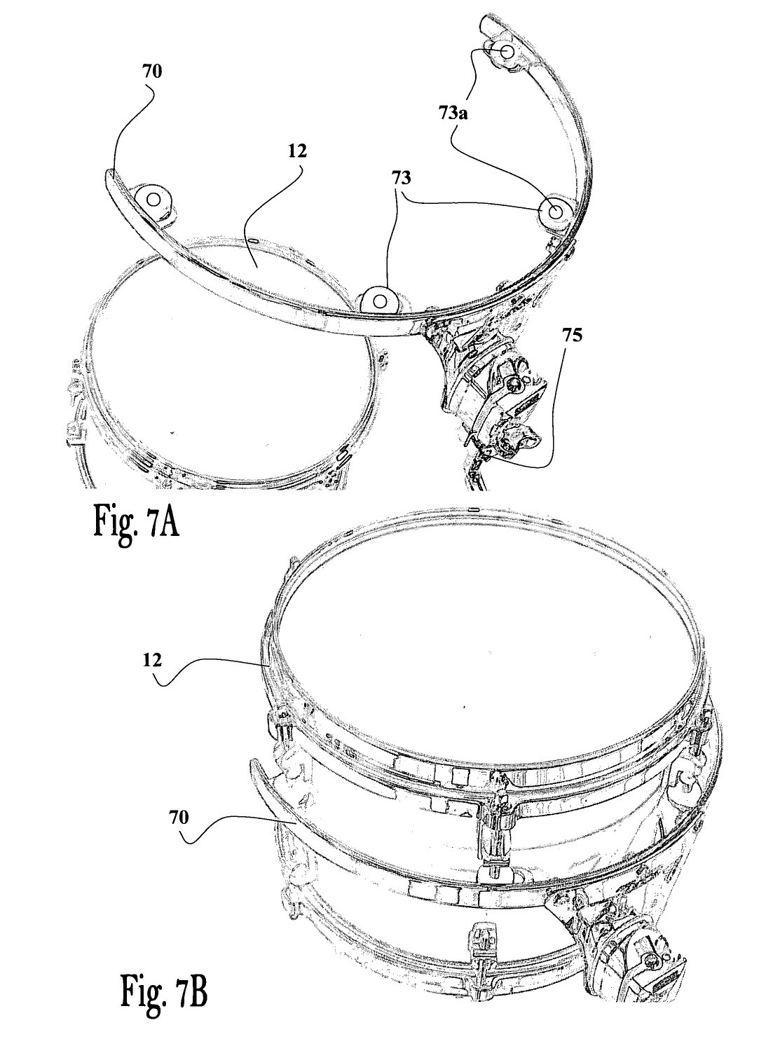

The objects of the invention are achieved utilizing unique drum construction employing one or more of the following features:
The drums of the nesting drum set of the invention are designed to be mounted on a removable suspension mount. More particularly, the drums of the nesting drum set of the invention have no mounting hardware permanently attached to them, and when set up to be played, are suspended in a playing position on mounting hardware in a new fashion, as will be described below (FIGS. 7A and 7B). The outer diameter of the drums without any mounting hardware attached to them is smaller than with the mounting hardware attached to them, and reducing the outer diameter allows fitting one drum inside another for packing;
Reduced wall thickness of the shell of the drum. The reduction of the drum shell wall thickness increases the drum shell's internal diameter, which provides more space inside each drum without affecting the outer diameter of the drum shell. For example, a 10″ tom tom shell made according to this specification still fits the standard 10″ diameter drum head (its outer diameter remains the same as that of a conventional 10″ tom tom shell), but it has a greater inner diameter and thus also greater internal volume than a conventional 10″ tom tom. The same example applies to all the drum sizes;
Reduced size of the drum lugs and other hardware connected to the drum shell. The reduction in the size of the drum lugs and any hardware connected to the drum shell means that the lugs and any other hardware protrude less from the drum shell. This reduces the overall outer diameter of the drum with lugs and hardware (if any); and/or
increased diameter of the drum shell while ensuring it still fits with the standard size drum head. This in fact means reduction of the distance between the drum shell and the drum head without increasing the thickness of the drum shell. This also increases the inner (and outer) diameter of the drum shell. This is done in a manner so that the drum shell still fits within the appropriate industry standard drum head.

It was found that having a drum designed for mounting with removable mounting hardware and having reduced lugs size (e.g., such that the lugs protrude from the wall of the drum shell about 15 to 20 mm) provides sufficient inner space for accommodating a drum having a similar design and head diameter smaller by circa 2″, while allowing packing the drum inside another drum having a similar design and a greater head diameter by Circa 2″ and definitely less than 3″.

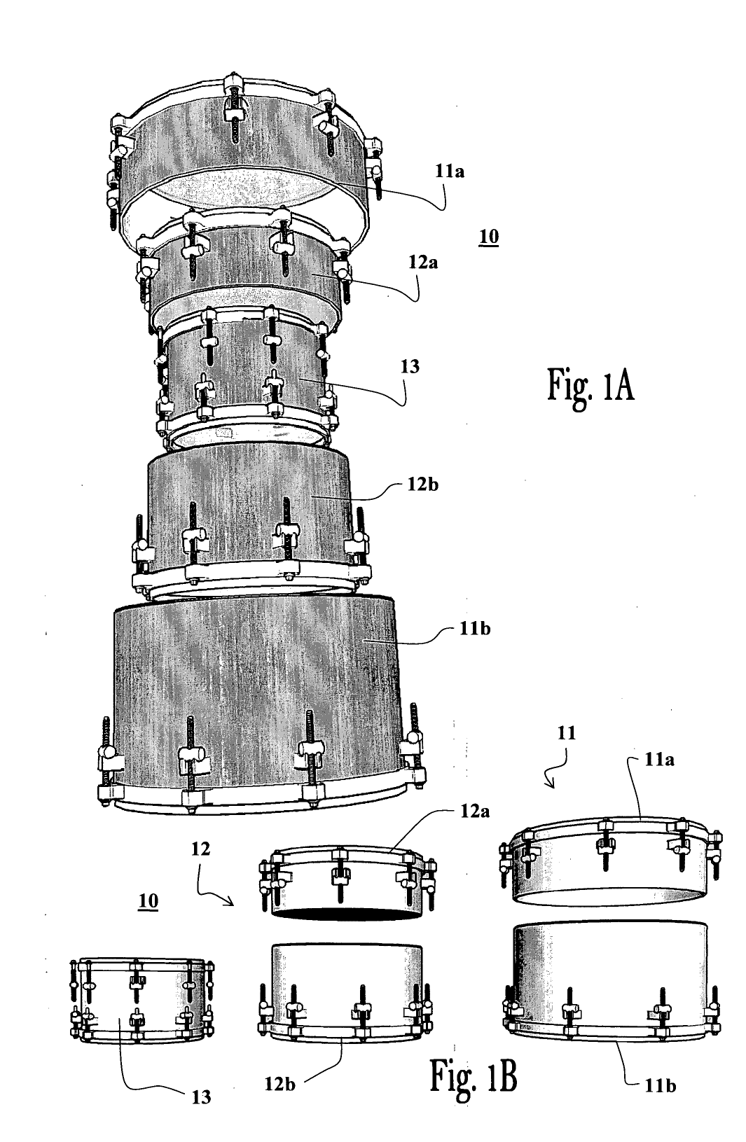

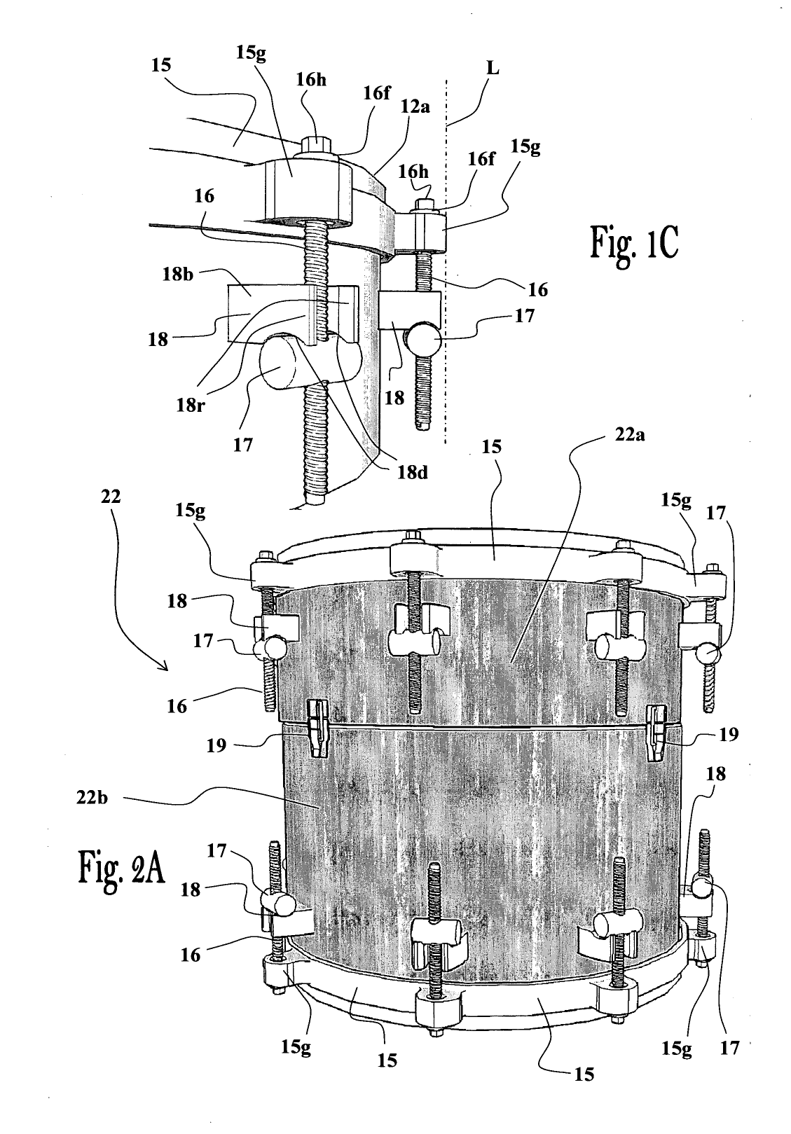

FIGS. 1A to 1C exemplify this preferred embodiment of the invention. FIG. 1A shows an exploded view of a nesting drum set 10 configuration of the invention as it is being packed, and FIG. 1B shows each of the drums of a nesting drum set 10 separately in an opened state. As shown in FIGS. 1A and 1B, in this example the nesting drum set 10 comprises three drums: a small size drum 13, an intermediate size drum 12, and a drum having a greater size 11, wherein the intermediate size drum 12 and the larger size drum 11 each comprises top shell portions, 12a and 11a respectively, and bottom shell portions, 12b and 11b respectively, configured to be secured to each other, while the smaller drum in not configured in such manner.

The diameter differences between the heads of drums 11 and 12, and between the heads of drums 12 and 13 are circa 2″, which is accomplished by configuring the drums for mounting on removable mounting hardware and by reducing their lug sizes. With reference to FIG. 1C, showing a closer view of a top shell portion 12a the upper opening of which is closed by a drum head (not shown) secured by fastening frame 15 to top shell portion 12a. Fastening frame 15 comprises fastening members 15g distributed about its perimeter each having a pass through bore through which a bolt 16 (also referred to herein as tension screw) is passed such that its head 16h and flange 16f members are placed over upper side of fastening members 15g. In this preferred embodiment of the invention each bolt 16 is received in a lug 18 having a base 18b attached to the external surface of the drum shell and a pair of arms 18r projecting therefrom in a radial direction relative to the shell, said arms 18r are substantially parallel and each extends from the bottom side of lug 18 to its upper side. The gap obtained between arms 18r is adapted to allow passage of bolt 16 through it such that it may be quickly changed between engaged and disengaged states by pivotally moving it in pass through bore about fastening members 15g. The bottom sides of arms 18r comprise oval dents 18d adapted to receive a cylindrical nut 17, said cylindrical nut 17 comprises a bore 17b passing in perpendicular to its cylinder axis about the middle of its length. Screw threads provided in the bore of the cylindrical nut 17 are adapted to mate with screw threads of bolt 16, thereby allowing securing fastening frame 15 to top shell portion 12a. Advantageously, this configuration of cylindrical nut 17 provides a nut member having an elongated and narrow profile such that it does not protrude beyond the tips of lugs 18r.

As demonstrated by broken line L the lugs 18 and nuts 17 in an assembled state do not protrude beyond fastening members 15g, namely, they do not protrude beyond the perimeter the fastening frames 15. At least some of bolts 16 are extended in length in order to allow for mounting the drum on a removable suspension mount, as shown in FIGS. 7A and 7B. The suspension mount 70 may be a conventional drum suspension unit having an arced shape comprising suspension ears 73 distributed about its inner side, wherein each suspension ear 73 comprises holes 73a for receiving bolts 16 when drum 12 is mounted thereon. A similar lug and bolt securing assembly may be provided in the bottom shell portion 12b of drum 12, as seen in FIG. 2A. The internal space of each drum in nesting drum set 10 may be further adjusted by constructing the top and bottom shell portions from material (e.g., wood, plastic, any type of metal, any type of composite materials, such as but not limited to carbon fiber, or any combination of these materials) having reduced wall thickness (e.g., about 1 mm to 4 mm), and/or by increasing the diameter of the top and bottom drum shell portions while ensuring they still fit within the appropriate standard size drum heads. Of course, adjustments of the wall thickness and shell diameter are not necessarily required since configuring the drums to be mounted on a removable suspension mount and reducing the sizes of the lugs is usually sufficient for allowing each of the drums to fit inside another drum the drum head of which is larger by circa 2″ in diameter, according to the drum configuration of the present invention.

Although a nesting drum set comprising three drums is demonstrated in FIGS. 1A and 1B it should be understood that the drum set configurations of the invention may be employed for constructing nesting drum sets comprising more than three drums having circa 2″ drum head diameter differences. For example, according to one preferred embodiment of the invention the drum set configuration of the invention may be used for constructing a nesting drum set comprising drums of the following sizes: 6″ 8″ 10″ 12″ 14″ 16″ 18″ 20″ 22″ 24″.

Drums 12 and 13 are provided with a fastening mechanism for closing their top shell portions over their bottom shell portions. FIG. 2A illustrates an external fastening mechanism used for example with drum 22 configured according to the drum configuration of the invention, wherein the fastening mechanism is implemented by means of draw latch units 19 provided on the outer surface about the perimeter of the top and bottom portions 22a and 22b of drum 22. Of course, other types of fastening means may be similarly used, such as, but not limited to, sash locks, link locks, and the like. FIG. 2B provides a closer view of drum 22 in an open state. As shown, in this state the parts of the fastening mechanism are separated having their latching part 19b attached near the upper opening of bottom shell portion 22b and a fastening part 19a attached near the bottom opening of top shell portion 22a.

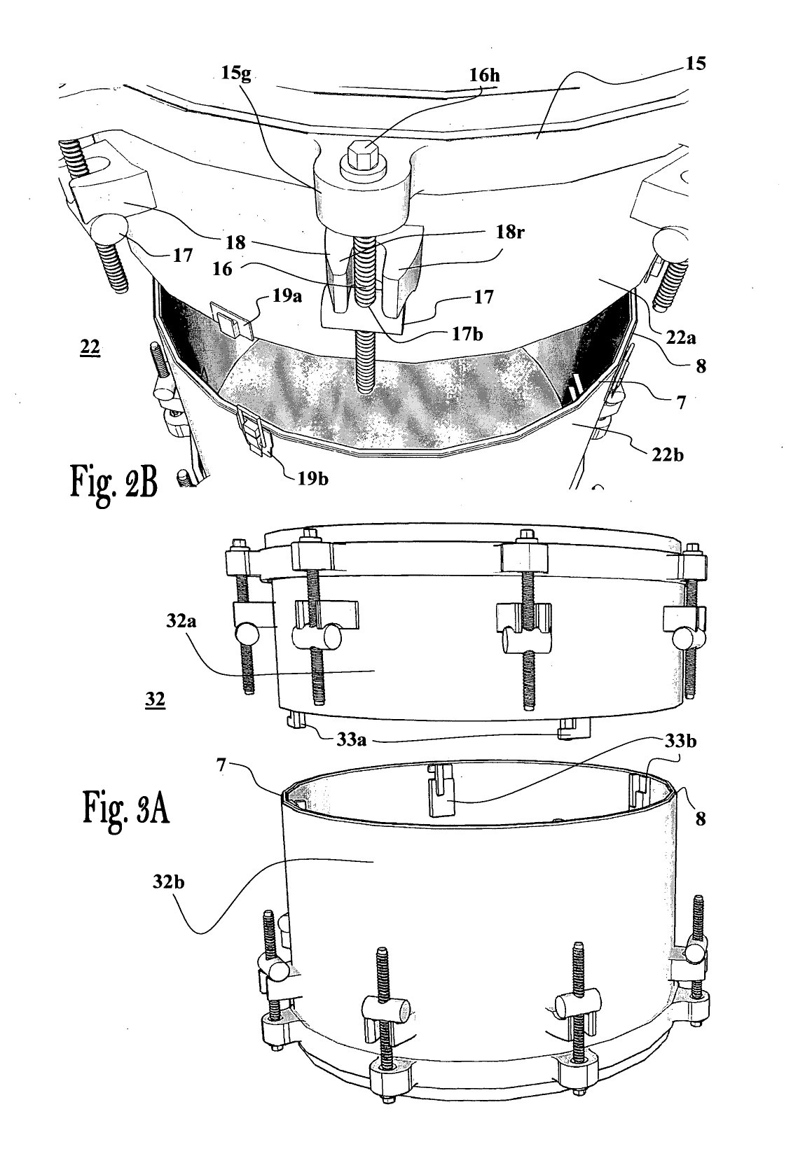

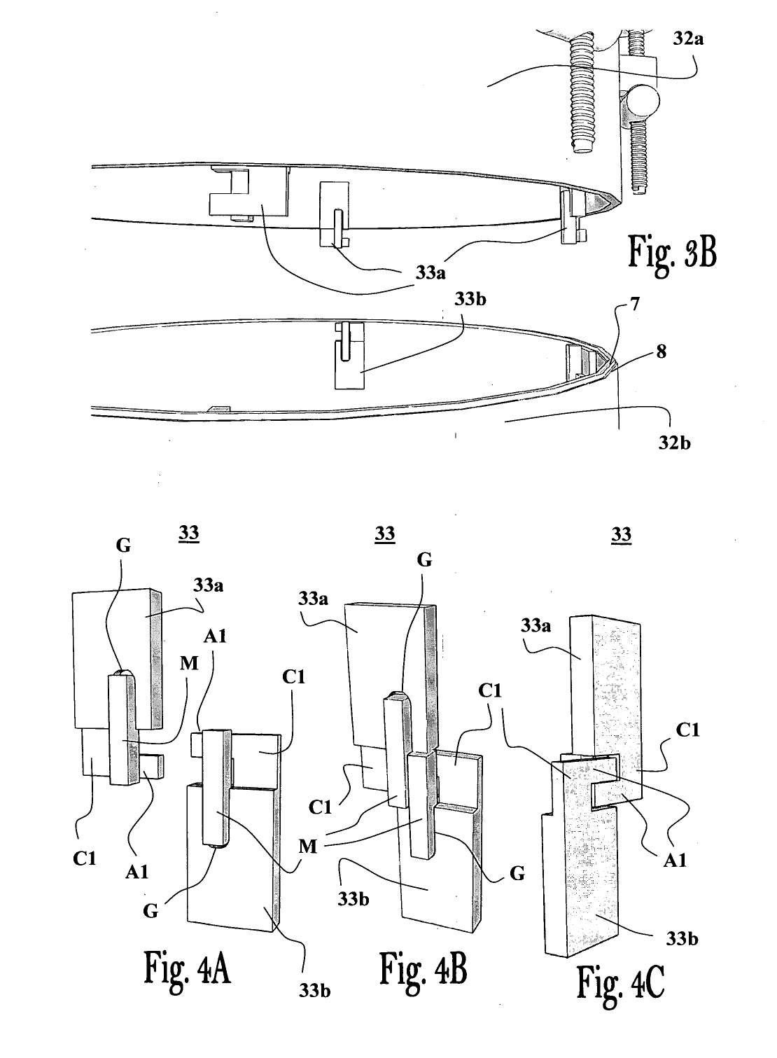

FIGS. 3A and 3B show another specific preferred embodiment of the invention wherein an internal fastening mechanism 33 is employed for closing top shell portion 32a over bottom shell portion 32b of a drum 32 configured according to the drum configuration of the invention. As shown, internal fastening mechanism 33 is comprised of top and bottom latching units 33a and 33b respectively attached to the internal surface of the top and bottom shell portions 32b and 32a, about their perimeter and near their openings. Top and bottom latching units 33a and 33b are designed to mate by placing the open side of top shell portion 32a over the open side of bottom shell portion 32b and rotating it thereabout until the latching units become engaged.

FIGS. 4A to 4C show perspective views of internal fastening mechanism 33 in engaged and disengaged states. As seen, latch units 33a and 33b may be made from a rectangular piece of material made from metallic, plastic, or any other suitable material, each comprising a base section to be attached to the shell surface and an “L”-shaped latching section C1 extending from said base section. Leg A1 of “L”-shaped latching section C1 defines a rectangular slot between it and the base section into which leg A1 of a mating latching unit is snugly fitted.

Preferably, the base sections of latch units 33a and 33b further comprise a groove G adapted to receive and hold an elongated magnet member M in it, such that a portion of elongated magnet member M is engaged in groove G and another portion thereof extends towards leg A1 of “L”-shaped latching section C1.

As seen in FIGS. 4B and 4C, in the engaged state each leg A1 is engaged inside the slot of the respective latch unit and the portions of elongated magnets extending from grooves G become attached to each other. Elongated magnets M are placed in grooves G in such a way that in the engaged states the opposite magnetic poles of the elongated magnets of latch units 33a and 33b are in contact so that attraction forces are obtained between them for securing the attachment of latch units 33a and 33b and preventing unintentional separation thereof. Elongated magnets M are preferably a type of permanent magnets such as Q-15-04-04-MN magnet of supermagnete (www.supermagnete.it), and capable of applying attraction forces of about 1.4 to 1.7 Kg, preferably of about 1.5 Kg. Elongated magnets M are preferably implemented by an elongated rectangular magnet element having a length of about 13 to 15 mm, and thickness of about 3 to 4 mm.

In a preferred embodiment of the invention latch units 33a and 33b are made from a metallic material, such as, but not limited to, steel or other metallic material that becomes magnetized once a magnet is attached thereto. Magnets M may be attached to latch units 33a and 33b by means of glue, screws, or any other suitable bonding means. Latch units 33a and 33b are preferably made from a rectangular piece of material having a length of about 22 mm to 38 mm, and thickness of about 5 mm to 7 mm.

In a preferred embodiment of the invention the drums may further comprise a seal 7 made of rubber, silicone, or any other suitable soft/flexible material that can be attached over the lip surface 8 of the bottom or top shell portions, about their openings, in order to circumferentially seal the attachment of the top and bottom shell portions of the drums. Seal 7 may be provided in a circumferential groove formed in the upper lip of the bottom shell portion (or in the lower lip of the top shell portion). Seal 7 is preferably attached to the lip area of the shell portion by adhesive means such as glue.

Inter alia, the drum set designs of the present invention allow drums with the following diameters to fit inside one another: They allow a 6″ drum to fit inside an 8″ drum, an 8″ drum to fit inside a 10″ drum, a 10″ drum to fit inside a 12″ drum, a 12″ drum to fit inside a 14″ drum, a 14″ drum to fit inside a 16″ drum, a 16″ drum to fit inside an 18″ drum, an 18″ drum to fit inside a 20″ drum, a 20″ drum to fit inside a 22″ drum, a 22″ drum to fit inside a 24″ drum, and a 24″ drum to fit inside a 26″ drum.

Obviously, this invention also allows a 13″ drum to fit inside a 15″ drum. As will be appreciated the drum set designs of the present invention allow to produce nesting drum sets comprising popular drum sizes that users are accustomed to and comfortable with.

As explained hereinabove, the present invention also provides a method for detachably suspending the drums in a playing position from the tension screws (bolts 16). As exemplified in FIGS. 1 to 3 tension screws 16 may be elongated elements having a length portion protruding beneath the drum lugs 18. A removable suspension mount 70 attached to a stand 75 may be used, wherein said removable suspension mount 70 comprises holes 73a configured to accommodate the bottom portion of the tension screws, as demonstrated in FIGS. 7A and 7B. In order to arrange the drums in a playing assembly, the user places the drums with the bottom of the tension screws inside the suspension mount, so the drum is ready to play, as shown in FIG. 7B. For packing, the drum can be easily removed from the suspension mount simply by lifting it upwardly from the suspension mount 70.

The present invention also provides a method for suspending the drums in a playing position from the lugs 18. In this specific preferred embodiment of the invention a special suspension mount is employed (not shown) which may be attached to a stand and which has holes adapted to accommodate the bottom face of the lugs of the drum. For playing, the user places the drum with the bottom of the lugs inside the suspension mount, so the drum is ready to play. For packing, the drum can be easily removed from the suspension mount as described above.

According to another specific preferred embodiment of the invention the drum shell may be constructed from an aluminum composite panel, preferably from a multilayered sheet comprising a plastic material, such as polyethylene sandwiched between two Aluminum layers. All the layers in this panel may be produced in various thicknesses. The use of such a panel allows the manufacturing of drums with specially enhanced desired qualities, inter alia:

1) with improved resonance;
2) with a wider range of tuning than obtained with drums of similar diameter and depth made of wood;
3) with a lower fundamental pitch of the drum than obtained with drums of similar diameter and depth made of wood.

The use of such multilayered shell material allows manufacturing a drum shell which is thinner than is possible with a wood drum shell, for example a 2 mm drum shell (the thinnest wood drum shells are more than 3 mm thick). It was found that a drum having such a thin shell wall (e.g., having a 2 mm wall thickness) from such multilayered material, has high attack and volume due to the material's acoustical proprieties.

In one specific preferred embodiment of the invention, the multilayered shell material comprises the following layers:

1) a high durability polyester coating;
2) an Aluminum layer;
3) an adhesive layer;
4) a Polyethylene layer;
5) an adhesive layer;
6) an Aluminum layer; and
7) a high durability polyester coating.

In other embodiments, the thickness of each layer of the drum shell and the amount of layers made can vary to create different acoustic qualities and weight to size ratios.

Drums of varying sizes and shapes including bass drums, tom toms, and others, can be made according to the present invention.

### Example

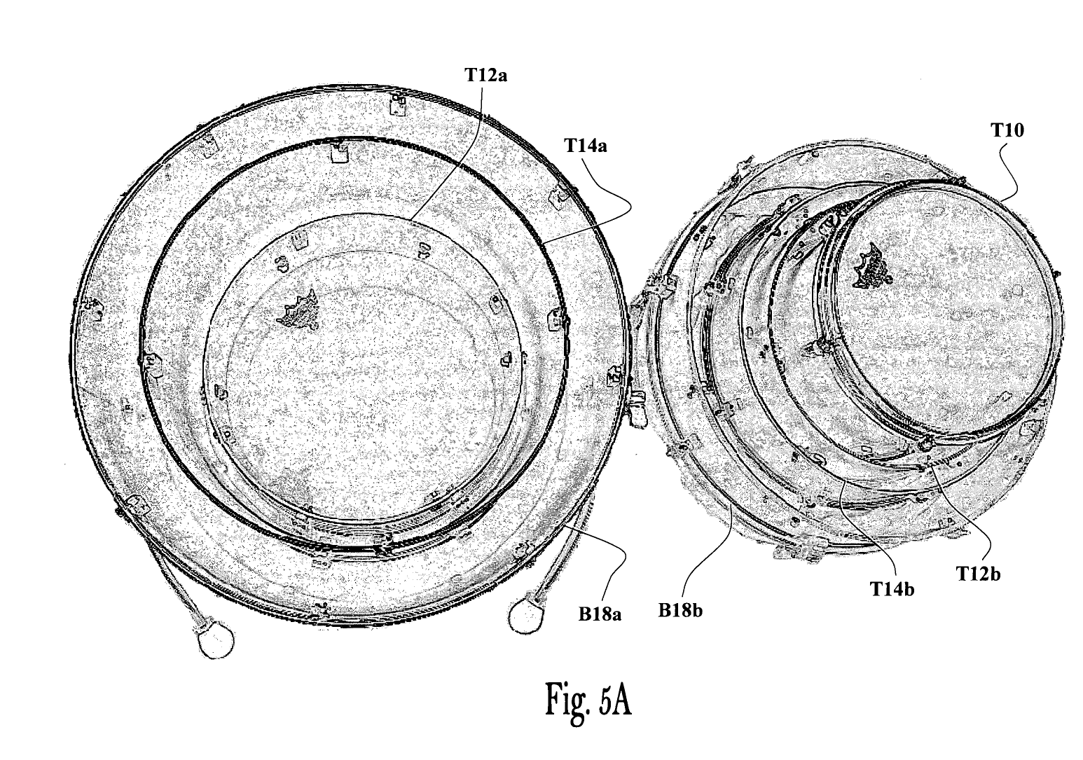

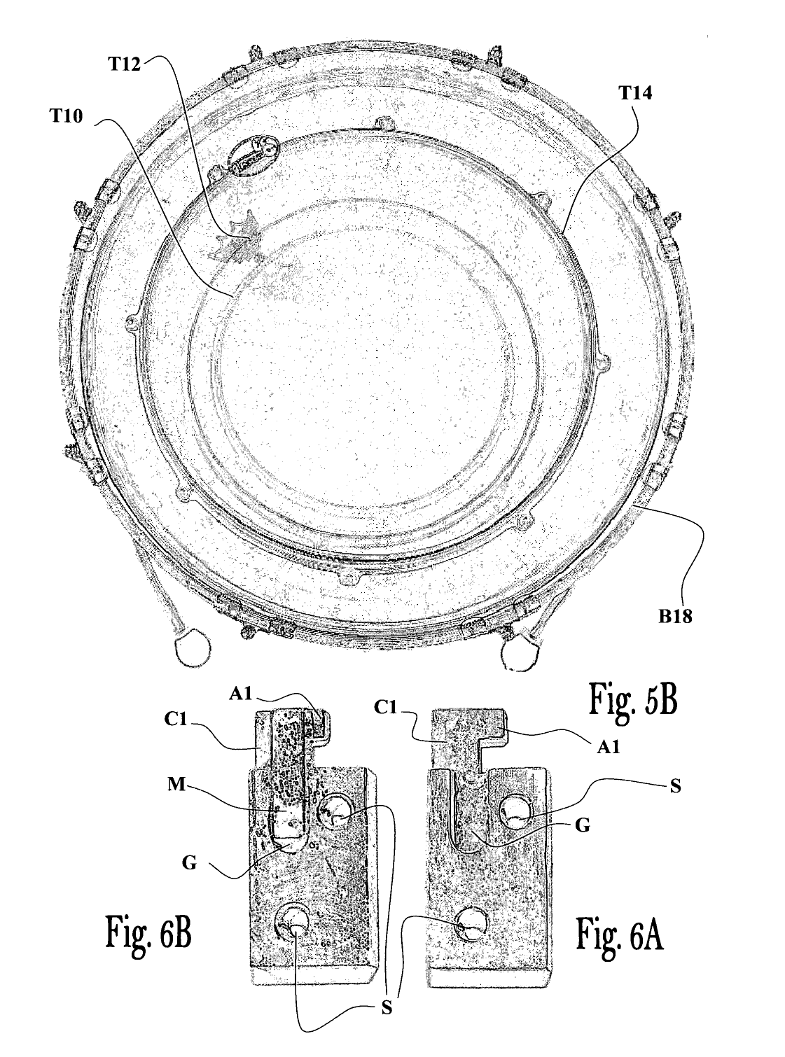

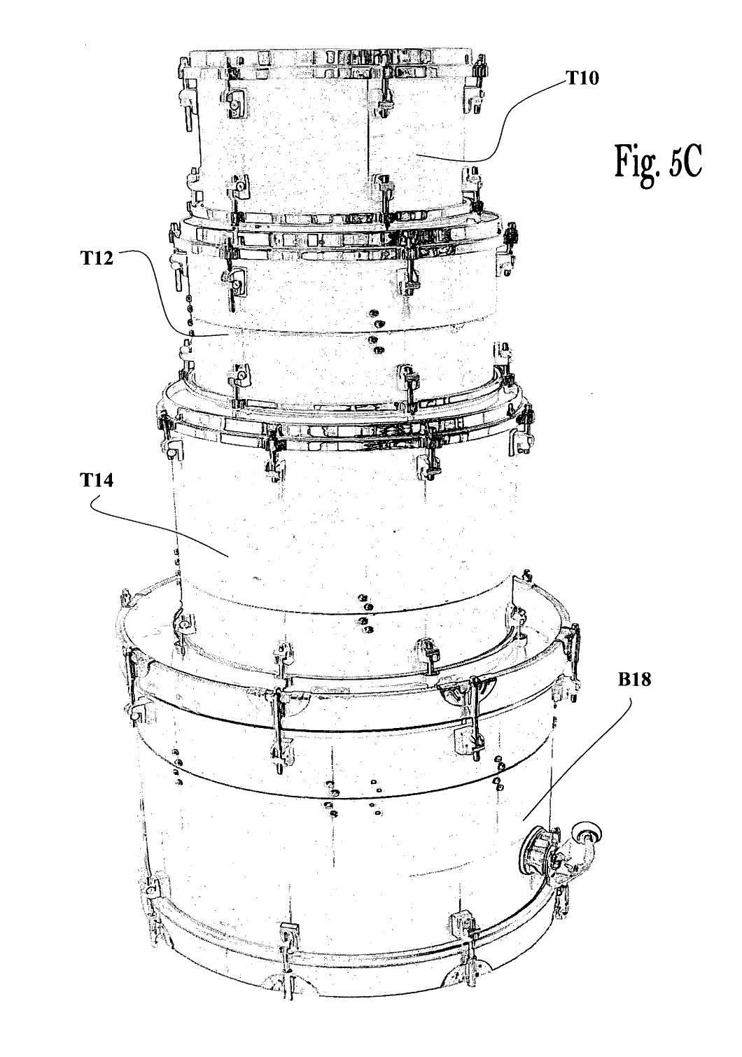

FIGS. 5A to 5C show images of a nested drum set design manufactured according to a drum set design of the invention. In this example the drum set comprises toms of 10″, 12″, 14″ and a bass drum of 18″ (T10, T12, T14, 318, respectively). The drums in this drum set were made utilizing reduced size of the lugs (about 18 mm) and they were configured to mount on a removable suspension mount. In FIG. 5A it is seen (in the top half of the photo) that the 10″ tom tom T10 is fitted inside bottom section T12b of the 12″ tom tom, which is fitted inside the bottom section T14b of the 14″ tom tom, where the bottom section T14b of the 14″ tom tom is fitted into the bottom section B18b of a 18″ bass drum. Also seen (in the bottom half of the photo) that the top sections of the 12″, 14″ and 18″ (T12a, T14a and B18a, respectively) of the drums T12 T14 and B18 also fit one inside the other in a similar nested fashion.

FIG. 5B shows the nested drum set after completing its packaging by closing the top portions of the drums over their bottom portions. In FIG. 5C the drums are seen closed and stacked one on top of the other, wherein the 10″ tom tom T10 is placed on top of the 12″ tom tom T12, which is placed on top of the 14″ tom tom T14, which is placed on top of the bass drum B18. The saving of space can easily be seen by comparing FIGS. 5B and 5C. In an embodiment of the invention which has more drums with sizes such as, for example, 8″, 10″, 12″, 14″, 16″, 18″ and 22″, the saving of space is even greater.

The drums in this example were manufactured from Maple wood having wall thickness of about 4 mm, and comprise an internal fastening mechanism of the invention (shown in FIGS. 3A, 3B, 4A, 4B, 4C, 6A, 6B). Standard drum heads and fastening frames were used in all of the drums. FIGS. 6A and 6B. show images of the latching units of the internal fastening mechanism used in this example, which is situated inside the drum shell, and is made of a steel part having screw alls S shown in FIG. 6A and grooves G to which a magnet M is attached, as seen in FIG. 6B.

The drum shell described in this invention can be made from one or more plies of materials such as for example various metals, rubber, plastic, wood, carbon fiber, Kevlar, carbon Kevlar, and other various composite materials. The thickness of each ply of the drum shell and the ratio between them can vary in different embodiments of the invention. The plies can be joined together by various glues appropriate to the materials of the plies or by other means. The drum shell described in this invention can also be made with various drum shell construction methods including stave construction, segmented drum shell construction, steam bent shell construction, or any other drum shell construction method. These variations permit, in different embodiments of the invention, drum shells with different weight to size ratios and different tonal qualities.

The drum shell in one specific preferred embodiment may be made from wood. The thickness of the shell in this specific preferred embodiment is about 4 mm. The hardware attached to the drum shell in this preferred embodiment is made of aluminum and steel, and protrudes less than 20 mm from the drum shell. This is less than the normal shell hardware, providing a decrease in the overall external diameter of the drum.

The decrease in the overall external diameter of each drum in the drum set and the absence of permanently connected mounting hardware makes possible the construction of a drum set in which each drum, apart from the largest drum, is packed inside another drum for storage and transport, even though the difference in diameter between a drum and the drum it is packed inside of can be as little as ˜2″.

A non limiting example of a nesting drum set that can be made with this method is:

An 8″ tom tom inside a 10″ tom tom inside a 12″ tom tom inside a 14″ tom tom inside a 16″ tom tom inside an 18″ tom tom inside a 22″ bass drum.

All of the abovementioned parameters are given by way of example only, and may be changed in accordance with the differing requirements of the various embodiments of the present invention. Thus, the abovementioned parameters should not be construed as limiting the scope of the present invention in any way.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1-30. (canceled)

31. A shell portion of a two shell drum configuration to facilitate nesting the shell portion in a larger shell portion of another drum, the shell portion comprising a shell including a latching mechanism to secure the shell portion to a matching shell portion during set up and to separate the shell portion from the matching shell portion during nesting, the shell portion having a diameter sized to receive an industry standard attachable drum head and an outermost perimeter sized to allow nesting the shell portion in another shell portion the head diameter of which another shell portion is only circa 2″ greater than that of the shell portion.

32. The shell portion of claim 31, wherein a shell of the shell portion has a wall thickness of less than 4 mm.

33. The shell portion of claim 31, wherein the shell portion is adapted to receive a fastening frame to the upper perimeter of the shell portion, the fastening mechanism being of the type having fastening members distributed about its perimeter, with each fastening member having a pass through bore through which a bolt is passed.

34. The shell portion of claim 33, wherein the fastening frame is sized to secure the industry standard attachable drum head to the shell portion.

35. The shell portion of claim 34, further comprising a lug attached near an outer perimeter of the shell portion for coupling the fastening frame to the shell portion, each lug being sized to receive a portion of the bolt extending from the fastening frame and dimensioned such that the outermost distance from the center of the shell portion does not exceed the outermost radius of the fastening frame.

36. The shell portion of claim 31, further comprising a plurality of lugs attached near an outer perimeter of the shell portion for coupling a fastening frame to the shell portion, each lug being sized to receive a portion of a bolt extending from the fastening frame and dimensioned such that the outermost distance from the center of the shell portion does not protrude beyond the outermost radius of the fastening frame.

37. The shell portion of claim 36, wherein each lug includes a pair of arms projecting radially from the shell portion, the pair of arms being sized to provide a channel through which the bolt passes and for adaptably coupling a fastener to secure the bolt and its attached fastening member to the shell portion.

38. The shell portion of claim 36, wherein the plurality of lugs are further sized such that the bolts passing therethrough may be adaptably coupled to a suspension mount without additional hardware.

39. The shell portion of claim 38, wherein the suspension mount is a drum suspension unit having an arched shape and including suspension ears distributed about its inner side, each suspension ear having holes for receiving the bolts when the shell portion is mounted thereon.

40. The shell portion of claim 31, wherein the latching mechanism is disposed and protrudes radially from an inner surface of the shell portion.

41. The shell portion of claim 31, wherein the latching mechanism operates to engage with a latching mechanism on the matching shell portion.

42. A musical drumming device for nesting in a larger shell portion of another drum, the drumming device including a plurality of lugs attached near an outer perimeter of the musical drumming device for coupling a fastening frame thereto, each lug being sized to receive a portion of a bolt extending from the fastening frame and dimensioned such that an outermost distance from a center of the musical drumming device does not protrude beyond the outermost radius of the fastening frame, the musical drumming device having a diameter sized to receive an industry standard attachable drum head.

43. The musical drumming device of claim 42, wherein each lug includes a pair of arms projecting radially from the musical drumming device, the pair of arms being sized to provide a channel through which the bolt passes and for adaptably coupling a fastener to secure the bolt and its attached fastening member to the musical drumming device.

44. The musical drumming device of claim 43, wherein the plurality of lugs are further sized such that the bolts passing therethrough are configured for coupling a suspension mount without additional hardware.

45. The musical drumming device of claim 44, wherein the suspension mount is a drum suspension unit having an arched shape and including suspension ears distributed about its inner side, each suspension ear having holes for receiving the bolts when the musical drumming device is mounted thereon.

46. A lug for connecting a fastening frame to a musical drumming device, the lug being sized to receive a portion of a bolt extending from the fastening frame and dimensioned such that when attached to an outer surface of the musical drumming device the lug does not protrude beyond the outermost radius of the fastening frame, the musical drumming device having a diameter sized to receive an industry standard attachable drum head.

47. The lug of claim 46, wherein the lug is for use on a musical drumming device configured to be nested in a larger shell portion of another drum during packaging.

48. The lug of claim 47, wherein the lug includes a pair of arms adapted to project radially from the musical drumming device, the pair of arms being sized to provide a channel through which the bolt passes and for adaptably coupling a fastener to secure the bolt and its attached fastening member to the musical drumming device.

49. The lug of claim 48, wherein the lug is further sized such that the bolt passing therethrough is configured for coupling the musical drumming device onto a suspension mount without additional hardware.

50. The lug of claim 49, wherein the suspension mount is a drum suspension unit having an arced shape and including suspension ears distributed about its inner side, each suspension ear having holes for receiving the bolts when the musical drumming device is mounted thereon.

51. A drum suspension unit comprising:
a base; and
a drum supporting portion, coupled to the base, sized to hold a musical drum in suspended fashion.

52. The drum suspension unit of claim 51, wherein the drum supporting portion includes means for suspending the musical drum without tightening the musical drum thereto for easy removal.

53. The drum suspension unit of claim 52, wherein the musical drum is of the type having bolts protruding from the base of respective lugs, the drum supporting portion being sized to hold the musical drum through holes arranged to receive the bolts in suspended fashion.

54. The drum suspension unit of claim 52, further comprising an arced shape and including suspension ears distributed about its inner side, each suspension ear bearing the holes for receiving the bolts.

55. A two-piece latching mechanism for connecting two shell portions of a two shell musical drum, each piece of the latching mechanism being configured to attach to a respective shell portion so as to secure the shell portions during set up and to allow separation of the shell portions during nesting of a drum within another drum.

56. The two-piece latching mechanism of claim 55, wherein each piece is configured to be disposed and protrude radially from an inner surface of the shell portion.

57. The two-piece latching mechanism of claim 55, wherein each piece is configured to engage with the other piece in rotating fashion.
